(19) United States
(12) Patent Application Publication
(10) Pub. No.: US 2005/0129086 A1
(43) Pub. Date: Jun. 16, 2005

(54) Induction furnace control

(76) Inventor: Louis Johannes Fourie, Gauteng Province (ZA)

Correspondence Address: DARBY & DARBY P.C., P. O. BOX 5257, NEW YORK, NY, 10150-5257, US

(21) Appl. No.: 10/501,385

(22) PCT Filed: Jan. 14, 2002
(86) PCT No.: PCT/IB02/00192

(51) Int. Cl. H05B 6/06

(52) U.S. Cl. 373/149

(57) ABSTRACT

An induction furnace is disclosed. The furnace has a hearth with sidewalls and a floor, and an electrical induction heater in communication with the hearth through the floor body means of a throat. In use metal contained in the hearth is heated to form a metal bath. The furnace is provided with means to control superheating of the metal bath by maintaining regions of the metal of the bath adjacent the sidewalls at least partly solidified.

### FIELD OF THE INVENTION

This invention relates to channel type induction furnaces used in the processing of metal and specifically, but not limited to, the control of such processes.

### BACKGROUND TO THE INVENTION

Induction furnaces are used to process metals by the melting and smelting thereof. An induction furnace normally has a refractory lined containment area, called the hearth, with an electrical induction heater located in the floor of the hearth. A pool of liquid metal, called the metal bath, has to be maintained in the furnace to ensure continuous operation. The liquid metal fills the induction heater to be heated therein. The floor, walls and pouring arrangement is normally designed to allow the metal to be drained from the induction heater by appropriate tilting of the furnace to facilitate replacement of the inductor and breaking out of the refractory materials in preparation for replacement.

Feed materials are charged into the metal bath from the top or the sides. The feed material will initially penetrate the metal bath until it comes to a rest on the hearth floor. Material charged subsequent to this will rest on top of the previously charged feed material. Material of lower density may float on the liquid surface.

The effect of the charging of relatively colder feed material is to lower the metal bath temperature. Some of the feed material will be in contact with the edges of the hearth. At the edges of the hearth, slag and frozen metal normally form a skull against the refractory lining, thereby providing a site onto which feed materials may be attached by way of some of the slag and metal from the bath freezing onto the lining.

A bridge of frozen and not yet reduced material can form over the metal bath through this mechanism. Such a bridge can grow with increasing amounts of cold feed material charged to the furnace. Eventually, the bridge may cover the whole of the metal bath surface and completely separate the liquid metal from the feed material above the bridge.

At this point, all of the metal under the bridge can be liquid and is prone to high degrees of superheating. Superheating occurs when a metal's temperature is increased to above its melting point. The degree of superheating is defined as the difference between the melting temperature and the actual temperature of the bath.

The operators of the furnace might be unaware of the superheating because of the physical barrier of the bridge in the furnace, causing them to inadvertently allow further superheating of the metal. From the operators point of view, the feed material does not appear to be melting and the normal response to this is to increase the energy input to the furnace.

The obvious danger of this is that the temperature of the metal bath can increase to above the safe operating temperature of the refractory lining, causing the lining to be eroded and eventually to burn through.

Another danger is that gasses, such as oxygen and nitrogen, may dissolve in the superheated metal to a much higher degree than would be the case if the metal temperature is maintained at lower levels.

If the refractory lining does not bum through, the metal bath temperature will reach a point where the bridge is sufficiently weakened to break under the weight of the feed material. This can cause a sudden penetration of the metal bath by the feed material, resulting in a sudden lowering of the metal bath temperature.

Cooling of the metal bath and especially solidification of the bath causes a lowering of the solubility of gas in the liquid metal. The effect of this is that a large volume of gas is expelled from the metal bath, causing what is commonly known as a boiling action that is dangerous to people and equipment near the furnace. This is more pronounced if there are more gasses dissolved in the metal.

Practices have been developed to ensure that superheating does not occur. These include constant temperature measuring of the metal bath and reducing the energy input when it becomes clear that superheating is occurring. It is not always possible to obtain a temperature measurement of the metal bath because of the thickness of the bridge over the metal bath. Additionally, the effect of reducing the energy input to the furnace is that the production rate of the furnace is lowered.

Practices have also been adjusted to ensure that a sufficient depth of liquid metal is retained after liquid metal has been tapped from the furnace and the addition of small amounts of feed materials to allow the charged material to be melted before further material is fed to the furnace. This means that feed materials that are charged, are rapidly submerged in the liquid bath.

This in turn means that feed material particles do not spend enough time above the liquid slag interface to be heated and potential surface area into which heat energy, other than heat derived from electrical energy, can be transferred is therefore lost. The remaining surface area into which heat energy, derived from combustion of fuel, can be transferred is the liquid slag surface.

This also has the result that almost all of the metal in the furnace is liquid at any given time, meaning that any delay in feeding the furnace with more feed materials will rapidly result in superheating of the metal bath. To overcome this, the energy input has to be reduced to control the metal temperature and to prevent possible permanent damage to the refractory lining.

It is therefore very difficult to constantly maintain the operation of an induction furnace at the point where the energy and feed material input is maximised and balanced to prevent either superheating of the metal bath or cooling of the furnace top and bridging of the charged material.

### OBJECT OF THE INVENTION

It is an object of this invention to provide an induction furnace and a method for operating an induction furnace which at least partly alleviates the above-mentioned difficulties.

### SUMMARY OF THE INVENTION

According to this invention there is provided an induction furnace with a hearth having sidewalls and a floor, an electrical induction heater in communication with the hearth through the floor by means of a throat to, in use, heat metal contained in the hearth to form a metal bath, characterised in that the furnace is provided with means to control superheating of the metal bath by maintaining regions of the metal bath adjacent the sidewalls at least partially solidified.

There is also provided for the means to control superheating to include means to substantially prevent charged feed material from contacting the sidewalls.

There is further provided for the superheat control means to include means to control the amount of slag in the furnace.

There is also provided for the means to control superheating of the metal bath to include maintaining an amount of feed material above the metal bath supported by a bridge of solidified metal or solidified slag or a combination of solidified metal and slag covering the metal bath, and for the amount of feed material to be sufficient to penetrate the bridge, as a result of weakening of the bridge through its heating, before the entire metal bath is melted.

The invention also provides for the furnace to have a shaft with an opening into the hearth through which the feed material is fed, the shaft to prevent feed material from contacting the sidewalls of the hearth.

A further feature of the invention provides for the metal bath depth, the shaft inner cross sectional area, and the distance between the shaft opening and the bridge, or any combination thereof, to be used to control the frequency of feed material penetrating the bridge.

A still further feature of the invention provides for preheating of the feed material to be done in the hearth and shaft, and for the preheating to be done through the combustion of fuel.

A further feature of the invention provides for a plurality of feed tubes to extend between the shaft and the hearth, for the feed material to be fed through the feed tubes to the hearth, and for the feed material to be at least partially and indirectly preheated in the feed tubes by means of heat transfer through the sides of the feed tubes.

In accordance with this invention there is also provided for a method of controlling superheating of the metal bath of an induction furnace as defined above, by maintaining the metal bath at least partly solidified through the steps of providing an amount of feed material on a solidified metal bridge over the metal bath,
heating of the metal bath,
causing the solidification front to move away from the throat thereby weakening the bridge and causing the feed material to penetrate the metal bath through the bridge before the entire metal bath is melted,
causing the metal bath temperature to be lowered and the solidification front to be moved closer to the throat to strengthen the bridge sufficiently to support subsequently fed material.

A further feature of the invention provides for the method to include the steps of removing slag from the furnace and preheating the feed material.

A further feature of the invention provides for the method to include the steps of using the metal bath depth, the shaft inner cross sectional area, and the distance between the shaft opening and the bridge, or any combination thereof, to control the frequency of feed material penetrating the metal bath.

### BRIEF DESCRIPTION OF THE DRAWINGS

An embodiment of the invention will be described below by way of example and with reference to the accompanying drawings in which:

FIG. 1 is a section through an induction furnace showing the state of the metal bath before penetration of the feed material.

FIG. 2 is a section through the same induction furnace after the feed material has penetrated the metal bath.

FIG. 3 is a perspective view of a second embodiment of the invention.

FIG. 4 is a perspective view of the second embodiment of the invention showing the furnace without the shaft sidewalls and the roof.

### DETAILED DESCRIPTION OF THE DRAWINGS

An induction furnace is generally indicated by numeral 1 in the drawings. The furnace (1) has a hearth (2) with a floor (3), sidewalls (4) and a roof (5) within which a charging shaft (6) is formed. The hearth (2) is lined with refractory material to contain the molten metal.

The furnace (1) is equipped with an induction heater (7) that is in communication with the hearth (2) through a throat (8) that opens in the floor (3). In use, the hearth (2) contains a metal bath (9) the metal bath (9) has an upper surface (10) that defines the upper extremity of the metal bath (9). The upper surface (10) can be covered with a slag layer (not shown). The upper surface (10) may solidify partly or fully to form a bridge (23) covering the metal bath (9). The metal bath (9) comprises liquid metal (11) and solidified metal (12) with a solidification front (13) between it.

The furnace (1) is used to melt and process scrap metal and previously reduced iron ore called DRI or direct reduced iron to produce liquid iron or steel. The furnace (1) is charged with feed material (14) through the shaft (6). The feed material can include scrap steel, DRI and the like, depending on the availability of feed materials and the required product. The initial charge of feed material (15) will pass through the shaft (6) to rest on the bridge (23) if the bridge (23) is strong enough, or to penetrate the bridge (23) to rest on the floor (3). Additional feed material (16) charged will rest on top of the first charged feed material (15) in the shaft (6).

The bridge (23) can support material (15) fed to the furnace through the shaft (6) and can grow to cover the entire upper surface (10) of the metal bath as will be explained further on. It is possible for the bridge to grow to proportions that enables it to carry all the charged feed material (15, 16) without breaking or sagging.

The shaft (6) is positioned to charge the feed material (15) generally in the area above the throat (8) and specifically not to charge any feed material (15) in a position where it can touch a sidewall (4). The amount of feed material (15) that actually rests on the bridge (23) is that under the triangle (17) formed by the extended angles of repose (18) of feed material and the bridge (23). The feed material (16) above the triangle (17) is to a large degree supported by the shaft sidewalls (19).

If the initial charge of feed material (15) rests on top of the bridge (23), the metal bath (9) and the feed material (15) will be separated by the bridge (23). Heating of the liquid metal (11) in the induction heater (7) increases the temperature of the liquid metal (11) to a small degree but, more importantly, causes melting of the solidified metal (12). This causes the solidification front (13) to move away from the throat (8) and changes the balance between the liquid metal (11) and solidified metal (12). The relative amount of liquid metal (11) is increased and the relative amount of solidified metal (12) decreased, although the total amount of metal in the metal bath (9) remains about the same (ignoring the addition of a small amount of bridge (23) metal to the metal bath (9) as it is liquefied by the above heating.

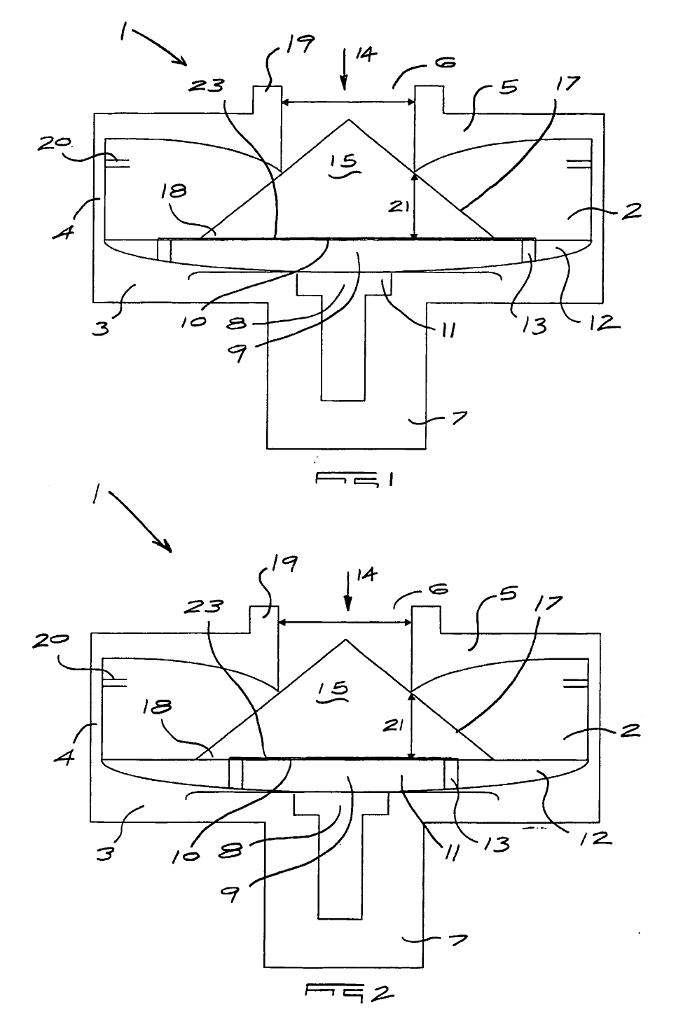

The amount of liquid metal (11) will continue to increase and the amount of solidified metal will continue to decrease with continued heating. This could continue until the situation shown in FIG. 1 is reached, where the solidification front is further away from the throat (8) than in FIG. 2, and the bridge (23) can no longer be supported by solidified metal. As the amount of liquid metal (11) increases through heating, the heating weakens the bridge (23) and decreases the amount of liquid metal (11) under the bridge increases simultaneously with a decrease in the amount of solidified metal (12) supporting the bridge (23) thereby further weakening it.

The result of the weakening of the bridge (23) is that a point is reached where it cannot support the weight of the feed material (15) resting on it and collapses. The feed material (15) penetrates the liquid metal (11) to rest on the floor (3), or subsides to makes good contact with the liquid metal (11), and some of material (16) from the shaft (6) moves downward to join feed material (15). The design of the furnace and the shaft is such that the point of penetration is reached before the whole of the metal bath (9) is liquefied.

The feed material (15) temperature is lower than that of the liquid metal (11) and therefore lowers the liquid metal (11) temperature with penetration. This temperature lowering causes the balance between the liquid metal (11) and solidified metal (12) to change with a relative increase of solidified metal (12) and relative decrease of liquid metal (11). The solidification front (13) therefore moves toward the throat (8). This is the situation shown in FIG. 2 where the solidification front (13) is closer to the throat (8) than in FIG. 1. Obviously, the total amount of metal in the metal bath increases after penetration of the feed material (15), but this is balanced by tapping from the furnace (1).

Once the feed material (15) has penetrated the upper surface (10), the feed material (16) above the triangle (17) will move down in the shaft (6). The bridge (23) will form again as a result of the cooling to be a barrier between the metal bath and the feed material (15) on top of it. The bridge (23) will be able to support the weight of the feed material (15) on top of it at this stage.

The process of heating of the liquid metal (11) will repeat, the amount of liquid metal will increase again with a concurrent decrease in the amount of solidified metal (12), and the solidification front (13) will be moved away from the throat (8) again, and so on as described above.

The process therefore repeats for as long as sufficient feed material (15) remains in place on top of the meniscus (10) to force the collapse of bridge (23) before the whole of the metal bath (9) is liquefied, and the energy input to the furnace (1) through the induction heater (7) is maintained.

In case the initial charge of feed material penetrates the meniscus, the process will proceed from the point where the liquid metal (11) decreases relative to the solidified metal (12) and the solidification front (13) has moved towards the throat (8), as shown in FIG. 2.

For additional energy efficiency, gas burners (20) are installed in the roof (5) or side walls (4) to heat the feed material (15) above the meniscus (10) and to exit through the shaft (6) to heat the feed material (16) located therein. This preheating of the feed material (15, 16) is very efficient because the heated gas passes through the feed material instead of over it, especially the feed material (16) located in the shaft (6). The preheating reduces the amount of electrical energy required to melt the feed material (15) after it penetrates the metal bath (9).

Additionally, the amount of solidified metal that will be liquefied before the bridge (23) collapses can be reduced by the preheating of the feed material (15). This is possible because preheating of the feed material (15) will also heat the bridge (23) from above to weaken it. This further aids in ensuring that a portion of the solidified metal (12) always remains in place to protect the furnace (1).

It is clear from the above description that it is necessary to prevent significant amounts of feed material touching the sidewall because it could be attached to sidewall (4) and strengthen the bridge (23). As stated before, such a strong bridge can support all the material (15) and (16) even if the whole of the metal bath (9) is liquefied. With additional heating, the liquid metal (11) will be superheated and create the danger of a bum-through of the furnace (1).

Additionally, the formation of a strong bridge and subsequent high liquid metal temperature will allow the dissolution of greater quantities of gas in the liquid metal. If the bridge is eventually sufficiently softened by the heating to collapse, the rapid cooling and solidification of the relatively large volume of liquid metal (11) due to contact with the feed material (15) will cause a rapid decrease in the solubility of gas in the liquid metal (11) and the expulsion of a large volume of gas from the liquid metal (11), causing the metal bath to boil which can lead to injury to people and damage to equipment.

The furnace design ensures a relatively large reservoir of solidified bath (12) by suitably adjusting the ratios of the shaft width (22), the height (21) of the shaft above the upper surface (10) and the width of the hearth (not shown) to the angle of repose (18) of the feed material.

If there is no feed material above the meniscus the whole of the metal bath will melt or become liquid and excessive superheating will take place with further heating. The present invention prevents this from happening by maintaining a suitable amount of feed material (16) in the shaft (6) and above the bridge (23) to eliminate the possibility of melting the reservoir of solidified metal (12), due to the assured feeding of material through the meniscus (10).

It is therefore apparent that the furnace can be operated with electrical energy input suitable for any desired production rate, even maximum rate continuously, without the problem of superheating of the metal bath. This is achieved by maintaining a suitable amount of feed material above the bridge and in the shaft. The amount is determined by the volume of feed material necessary to ensure that the feed material supply frequency and batch size does not result in the material above the bridge and in the shaft to be depleted before it can be replenished. This, together with the reservoir of solidified metal (12) prevents superheating. As far as the operator is concerned, superheating is therefore prevented by ensuring that the charging shaft (16) is kept fully charged with feed material (15, 16).

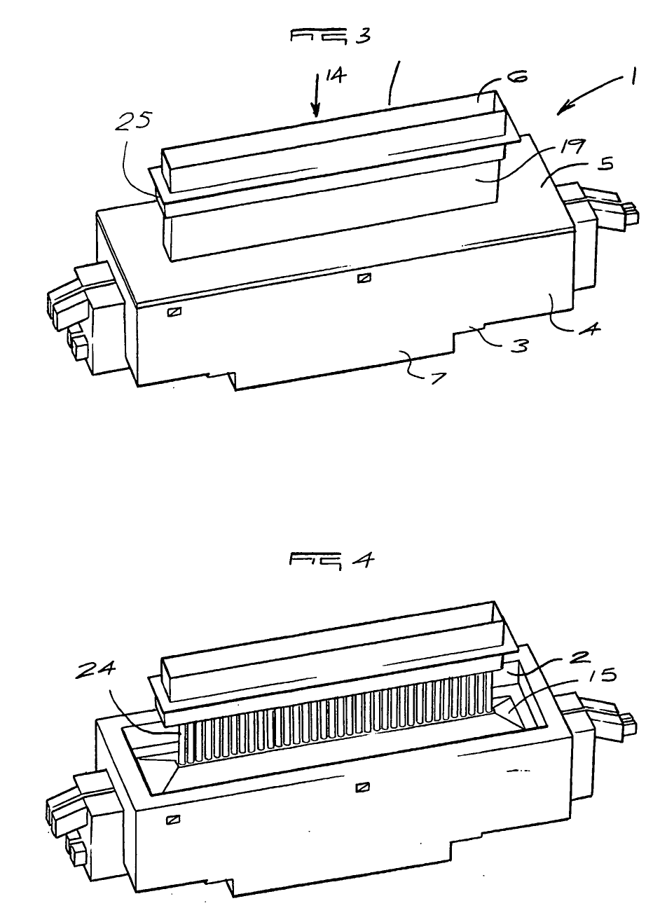

A second embodiment of an induction furnace according to the invention is shown in FIGS. 3 and 4, in which like features are numbered the same as in FIGS. 1 and 2.

FIG. 3 shows a perspective view of a furnace (1) according to the second embodiment. As can be seen the furnace (1) has a feed hopper (6), a roof (5), sidewalls (4), a floor (3), and an induction heater (not shown) in communication with the hearth (not shown) through a throat (7). The outer shaft (19) around the inner shaft (not shown) allow the gasses formed during melting and by combustion of fuel to pass around the inner shaft before being exhausted. The gasses are exhausted through an outlet (25) underneath the hopper (6). In this embodiment the inner shaft comprises a plurality of feed tubes (24) that extend between the feed hopper (6) and the hearth (2).

In FIG. 4 the furnace (1) is shown with the outer shaft (19) and roof (5) removed. This shows the feed material (15) in the furnace (1).

The advantage that this arrangement offers is that fine, low permeability material can be preheated without the combustion gasses coming into contact with the material. This arrangement also contributes to feeding the feed material evenly to the furnace.

It will be understood that the above are only two examples of induction furnaces and a method of controlling them according to the invention, and that there are also other embodiments of the invention.

For example, the shaft can be designed to be vertically movable. This allows the height of the shaft above the meniscus to be changed according to changes in operating conditions and provides a further level of control over the process, by enabling the access of combustion gas to the shaft to be varied as a function of the feed material characteristics.

It is also possible to operate induction furnaces used for the processing of other metals, such as copper and brass, according to this invention. For such other metals, specific furnace and shaft design will likely be different from that of a steel induction furnace but the principle will be the same.

It is also possible to have heaters in the shaft sidewalls to further improve the preheating of the feed material.

1. An induction furnace with a hearth having sidewalls and a floor, and an electrical induction heater in communication with the hearth through the floor by means of a throat to, in use, heat metal contained in the hearth to form a metal bath, characterised in that the furnace is provided with means to control superheating of the metal bath by maintaining regions of the metal bath adjacent the sidewalls at least partly solidified.

2. A furnace as claimed in claim 1 in which the superheating control means includes means to substantially prevent charged feed material from contacting the sidewalls.

3. A furnace as claimed in claim 2 in which the furnace includes a central charging shaft above the hearth.

4. A furnace as claimed in claim 3 in which the feed material is substantially prevented from contacting the sidewalls by charging the feed material through the shaft to the centre of the furnace.

5. A furnace as claimed in any one of claims 1 to 4 in which a bridge of slag or metal, or a combination thereof, is formed over at most part of the metal bath and the bridge at least partly supports charged feed material.

6. A furnace as claimed in claim 5 in which the feed material penetrate the bridge at a determinable frequency and the furnace is designed to operate at the frequency of bridge penetrations through use of the parameters of liquid metal bath depth, shaft inner cross sectional area, and the distance between the shaft opening into the hearth and the bridge.

7. A furnace as claimed in claim 6 in which the furnace is designed to have an amount of feed material supported by the bridge that is adequate to collapse the bridge into the liquid metal before the heating of metal bath causes the entire metal bath to be melted.

8. A furnace as claimed in any one of claims 1 to 7 in which the superheat control means includes means to control the amount of slag in the furnace.

9. A furnace as claimed in claim 8 in which the furnace includes means to preheat the feed material.

10. A furnace as claimed in claim 9 in which the feed material is preheated in the hearth and the shaft.

11. A furnace as claimed in claim 9 or 10 in which the feed material is preheated through the combustion of fuel.

12. A furnace as claimed in anyone of claims 9 to 11 in which the furnace includes feed tubes extending between the shaft and the hearth, feeding of feed material is done through the feed tubes, and preheating is at least partially done in the feed tubes.

13. A method of controlling superheating of a metal bath of an induction heated furnace with a hearth having sidewalls and a floor, and an electrical induction heater in communication with the hearth through the floor by means of a throat, by maintaining the metal bath at least partly solidified.

14. A method as claimed in claim 13 in which the metal bath is maintained at least partly solidified in regions of the metal bath adjacent the sidewalls.

15. A method as claimed in claim 14 in which the metal bath is maintained at least partly solidified by allowing a bridge of solidified slag or metal, or a combination thereof, to form over the metal bath and preventing the bridge from contacting the sidewalls.

16. A method as claimed in claim 15 in which the bridge is prevented from contacting the sidewalls by preventing feed material from contacting the sidewalls.

17. A method as claimed in claim 16 in which feed material is prevented from contacting the sidewalls by charging feed material to the centre of the furnace through a charge shaft located centrally above the hearth.

18. A method of operating an induction heated furnace with a hearth having sidewalls and a floor, and an electrical induction heater in communication with the hearth through the floor by means of a throat, including the steps of
a. providing a metal bath in the hearth, the metal bath including regions of at least partly solidified metal adjacent the sidewalls to form a solidification front between the at least partly solidified metal and liquid metal in the bath;
b. charging feed material into the furnace;
c. allowing a bridge of solidified metal or slag, or a combination thereof, to form over at most part of the metal bath, the bridge supporting at least part of the charged feed material;
d. heating the metal bath to cause the solidification front to move into the partly solidified metal and the bridge to be weakened to the point where the weight of the feed material supported by the bridge causes the feed material to collapse the bridge into the liquid metal and the feed material to penetrate into the liquid metal;
e. allowing the penetrated feed material or collapsed bridge to lower the temperature of the liquid metal to cause the solidification front to move closer to the throat;
f. allowing the bridge to be reformed to support subsequently charged feed material; and
g. tapping molten metal from the furnace.

19. A method as claimed in claim 18 in which step 18.b includes charging feed material substantially to the centre of the furnace.

20. A method as claimed in claim 19 in which the feed material is charged through a central charging shaft above the hearth.

21. A method as claimed in anyone of claims 18 to 20 which include the step of preheating the feed material.

22. A method as claimed in claim 21 in which the feed material is preheated in the hearth and the shaft.

23. A method as claimed in claim 21 or 22 in which the feed material is preheated through the combustion of fuel.

24. A method as claimed in any one of claims 18 to 22 which include the step of removing slag from the furnace.
